(19) United States
(12) Patent Application Publication
(10) Pub. No.: US 2006/0098686 A1
(43) Pub. Date: May 11, 2006

(54) Frame transmitting apparatus and frame receiving apparatus

(76) Inventors: Makoto Takakuwa, Kawasaki (JP); Futoshi Izumi, Kawasaki (JP); Masahiro Yoshimoto, Kawasaki (JP); Takahiro Hosokawa, Kawasaki (JP)

Correspondence Address: SWIDLER BERLIN LLP, 3000 K STREET, NW, BOX IP, WASHINGTON, DC, 20007, US

(21) Appl. No.: 11/067,401

(22) Filed: Feb. 28, 2005

(30) Foreign Application Priority Data
Nov. 9, 2004 (JP) 2004-325160

(51) Int. Cl. H04J 3/16

(52) U.S. Cl. 370/470

(57) ABSTRACT

A frame transmitting apparatus that transmits a frame including data to be transmitted or a frame including control data for a data-transmission control via a network includes a frame generating unit that generates a frame including identification-information-added data to which 1-bit identification information indicating whether a block obtained by dividing data into every n bits includes the control data is added, where n is a positive integer, and an error control code for a data-transmission error control; and a frame transmitting unit that transmits the frame generated.

### BACKGROUND OF THE INVENTION

1) Field of the Invention

The present invention relates to a technology for controlling a transmission error of data, reducing a transmission band required for transmitting data, and suppressing a processing speed required for an apparatus that performs a data transmission, when transmitting and receiving a frame including data to be transmitted or a frame including control data for a transmission control.

2) Description of the Related Art

Conventionally, a frame format called “LAN-PHY” is defined in a standard of 10 Gigabit Ethernet (registered trademark). Specifically, the frame format of LAN-PHY is a frame format obtained by adding a 2-bit header to each 64 bits in a MAC frame and performing conversion to a 66-bit block. A processing for the conversion is generally called “64B/66B coding”.

When data is included alone in the LAN-PHY frame, a value of the 2-bit header is set to “01”. When control code is included in the LAN-PHY frame, the value of 2-bit header is set to “10”. Thus, the header is used to determine information included in the frame.

When the 2-bit header is set to “01” or “10”, such a pattern that a value is reversed from 0 to 1 or from 1 to 0 is detected for each 66 bits. Therefore, the 2-bit header can be also utilized for frame synchronization.

Now, when a 2-bit header is added, it is necessary to further increase a processing rate of a device for performing data transmission, which results in increase in cost. Therefore, Japanese Patent Application Laid-Open Publication No. 2002-271308 has disclosed a code communication method that converts a code with n-bit length mB/nB-coded to a code with (m+1)-bit length to perform communication.

Specifically, in the code communication method, a transmission band required for data transmission is reduced by adding a 1-bit control bit for identifying whether a code is a data code for transmitting data or it is a special code for transmitting data code instead of adding a 2-bit code. Further, in the code communication method, it is made possible for a device that has received a code to perform code synchronization by transmitting a code synchronization pattern for performing code synchronization at least one time.

In the conventional technique disclosed in Japanese Patent Application Laid-Open Publication No. 2002-271308, however, there is a problem that, when transmission error of data occurs, it is difficult to solve the error. Specifically, when data is transmitted via an optical fiber according to a wavelength-division-multiplexing (WDM) system, a possibility that transmission error of data occurs is increased due to a non-linear optical effect that an optical fiber has such as self phase modulation (SPM) or cross phase modulation (XPM), where there is a problem that it is difficult to detect such transmission error.

When a 2-bit header is added like the LAN-PHY frame, since a value of the header is not set to “00” or “11”, a transmission error rate of data can be estimated from information about a reception frequency of a frame having a value of a header such as “00” or “11” so that alarm is generated. As the conventional technique such as disclosed in the Patent Literature 1, however, when the 2-bit header is replaced by a 1-bit control bit, it becomes very difficult to control transmission error.

When long distance transmission of data is performed via a broad band network such as synchronous digital hierarchy (SDH)/synchronous optical network (SONET), it becomes further important to control transmission error because optical loss increases. Therefore, it becomes important to solve a problem about how to control transmission error of data efficiently and how to suppress a processing rate required for a device for performing data transmission are serious problems.

### SUMMARY OF THE INVENTION

It is an object of the present invention to solve at least the above problems in the conventional technology.

A frame transmitting apparatus according to one aspect of the present invention, which transmits a frame including data to be transmitted or a frame including control data for a data-transmission control via a network, includes a frame generating unit that generates a frame including identification-information-added data to which 1-bit identification information indicating whether a block obtained by dividing data into every n bits includes the control data is added, where n is a positive integer, and an error control code for a data-transmission error control; and a frame transmitting unit that transmits the frame generated.

A frame receiving apparatus according to another aspect of the present invention, which receives a frame including data to be transmitted or a frame including control data for a data-transmission control, includes a frame receiving unit that receives a frame including identification-information-added data to which 1-bit identification information indicating whether a block obtained by dividing data into every n bits includes the control data is added, where n is a positive integer, and an error control code for a data-transmission error control; a transmission-error control unit that executes a data-transmission error control based on the error control code included in the frame received; and a format converting unit that performs, when the data-transmission error control has been executed, a conversion of a frame format based on the identification information.

A frame transmitting apparatus according to still another aspect of the present invention, which transmits a frame including data to be transmitted or a frame including control data for a data-transmission control via a network, includes a frame generating unit that generates a frame by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format; and a frame transmitting unit that transmits the frame generated.

A frame receiving apparatus according to still another aspect of the present invention, which receives a frame including data to be transmitted or a frame including control data for a data-transmission control, includes a frame receiving unit that receives a frame generated by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format; a transmission-error control unit that executes a data-transmission error control based on the error control code included in the frame received; and a format converting unit that performs, when the data-transmission error control has been executed, a conversion of a frame format based on the information relating to the control data.

A method according to still another aspect of the present invention, which is for transmitting a frame including data to be transmitted or a frame including control data for a data-transmission control via a network, and receiving the frame transmitted, includes generating a frame including identification-information-added data to which 1-bit identification information indicating whether a block obtained by dividing data into every n bits includes the control data is added, where n is a positive integer, and an error control code for a data-transmission error control; transmitting the frame generated; receiving the frame transmitted; executing a data-transmission error control based on the error control code included in the frame received; and performing, when the data-transmission error control has been executed, a conversion of a frame format based on the identification information.

A method according to still another aspect of the present invention, which is for transmitting a frame including data to be transmitted or a frame including control data for a data-transmission control via a network, and receiving the frame transmitted, includes generating a frame by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format; transmitting the frame generated; receiving the frame transmitted; executing a data-transmission error control based on the error control code included in the frame received; and performing, when the data-transmission error control has been executed, a conversion of a frame format based on the information relating to the control data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram for explaining a concept of a frame transmission processing according to the present invention;

FIG. 2 is a diagram for explaining a frame structure of a digital wrapper frame;

FIG. 3 is a block diagram of a configuration of a frame transmitting system according to a first embodiment of the present invention;

FIG. 4 is a block diagram of a functional configuration of a transponder shown in FIG. 3;

FIG. 5 is a flowchart of a process procedure of a process for converting a LAN-PHY frame to a digital wrapper frame to transmit;

FIG. 6 is a flowchart of a process procedure of a process for converting a digital wrapper frame to a LAN-PHY frame;

FIG. 7 is a block diagram of a functional configuration of a rooter according to a second embodiment of the present invention;

FIG. 8 is a flowchart of a process procedure of a process for converting a MAC frame to a digital wrapper frame to transmit;

FIG. 9 is a flowchart of a process procedure of a process for converting a digital wrapper frame to a MAC frame to transmit; and

FIG. 10 is a block diagram of a functional configuration of an uninterruptible LAN-PHY device.

### DETAILED DESCRIPTION

Exemplary embodiments of a frame transmitting apparatus and a frame receiving apparatus according to the present invention will be explained below in detail with reference to the accompanying drawings.

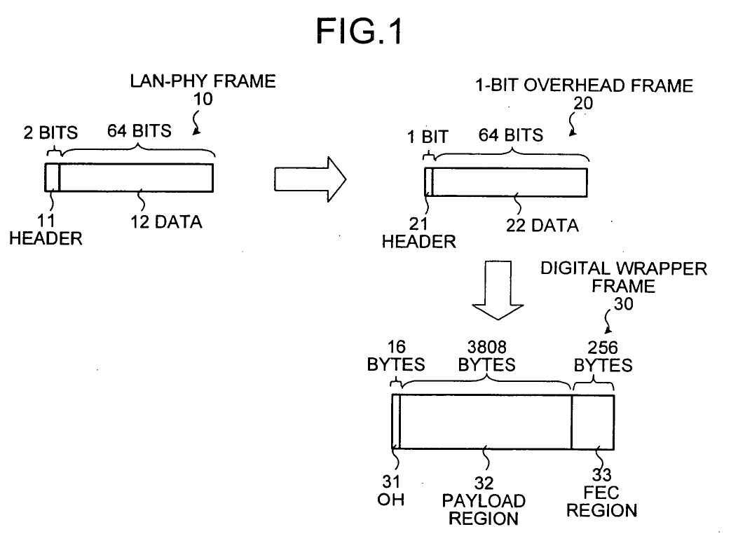

FIG. 1 is a diagram for explaining a concept of a frame transmission processing according to the present invention. As shown in FIG. 1, in the frame transmission processing, first, a processing for replacing a 2-bit header 11 in a LAN-PHY frame 10 generated by 64B/66B-coding data based on a standard for 10GLAN-PHY by a 1-bit header 21 to generate a 1-bit overhead frame 20 is performed.

The LAN-PHY frame 10 is a frame having a 2-bit header 11 (or a header 11 constituted of 2 bits) and 64-bit data 12, and the 1-bit overhead frame 20 is a frame having a 1-bit header 21 and 64-bit data 22.

Specifically, in the frame transmission processing, when a value of the 2-bit header 11 is “01”, the header 11 is replaced by the 1-bit header 21 having a value of “0”. When the value of the 2-bit header 11 is “10”, the header 11 is replaced with the 1-bit header 21 having a value of “1” (on the contrary, such a constitution may be employed that the header 11 having a value of “01” is replaced by the header 21 having a value of “1” and the header 11 having a value of “10” is replaced with the header 21 having a value of “0”).

Further, in the frame transmission processing, a processing for producing a digital wrapper flame 30 where the 1-bit overhead frame 20 has been embedded in a payload area 32 to transmit the digital wrapper frame 30 is performed.

The digital wrapper is a frame format technique contained in Recommendation G.709 in International Telecommunication Union-Telecommunication Standardization Sector (ITU-T). A frame for the digital wrapper is constituted of a 16-byte Overhead (OH) 31, a 3808-byte payload area 32, and a 256-byte Forward Error Collection (FEC) area 33.

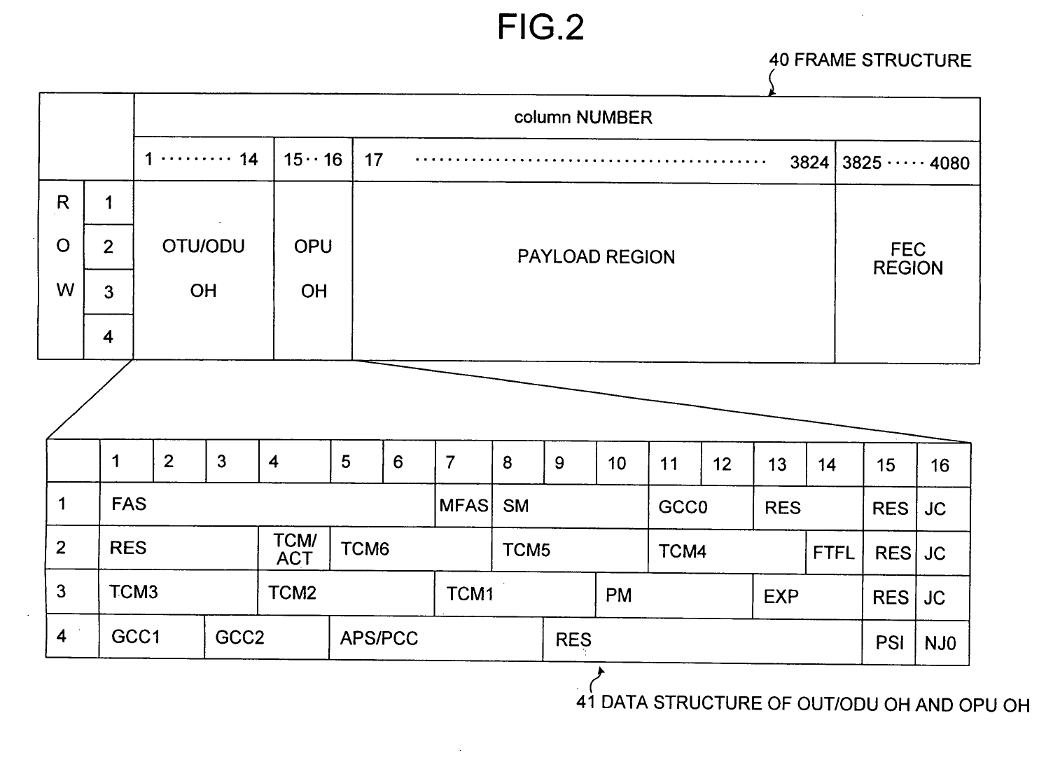

FIG. 2 is a diagram for explaining a frame structure 40 of a digital wrapper frame. As shown in FIG. 2, the digital wrapper frame is constituted of four rows having 4080 bytes.

In each row, an area from the 1^{st} byte to the 14^{th} byte (column numbers of 1 to 14) is an optical channel transport unit/optional channel data unit overhead (OUT/ODU OH), an area from the 15^{th} byte and 16^{th} byte (column numbers of 15 and 16) is an OPU OH.

The OUT/ODU OH and OPU OH are used for storing respective information elements concerning operation and management for a frame. The OUT/ODU OH and OPU OH correspond to the OH 31 shown in FIG. 1.

In FIG. 2, a data structure 41 of the OUT/ODU OH and OPU OH is shown in detail. An area for storing operation and management information such as a frame alignment signal (FAS) is preliminarily defined in the OUT/ODU OH and OPU OH.

Here, the FAS is a frame synchronizing code referred to for performing frame synchronization. In FIG. 2, an area displayed as RES is a reserved area which is not in use.

In each row, an area from the 17^{th} byte to the 824^{th} byte (column numbers of 17 to 3824) is a payload area, which is an area in which user data to be transmitted is stored. The payload area corresponds to the payload area 32 shown in FIG. 1.

In each row, an area from the 3825^{th} byte to the 4080^{th} byte (column numbers of 3825 to 4080) is an FEC area, which is an area in which an error correcting code for correcting transmission error of data according to a forward error control system is stored. The FEC area corresponds to the FEC area 33 shown in FIG. 1.

By converting the 66-bit LAN-PHY frame 10 to the 65-bit 1-bit overhead frame 20 (or the 1-bit overhead frame constituted of 65 bits) and further embedding the 1-bit overhead frame 20 into the digital wrapper frame to transmit the same in this manner, a processing rate of a network device that performs frame transmission can be reduced.

Specifically, when a signal of 10GLAN-PHY of 10.0 Gbps that has been 64B/66B-coded and has been further stored in the 3808-byte payload area 32 in the 4080-byte digital wrapper frame 30 is transmitted, a processing rate required for a network device becomes 10.0×66/64×4080/3808=11.04910714 (Gbps).

On the other hand, when a signal of 10GLAN-PHY of 10.0 Gbps that has been converted to a 65-bit signal and has been further stored in the 3808-byte payload area 32 in the 4080-byte digital wrapper frame 30 is transmitted like the frame transmission processing of the present invention, a processing rate required for a network device becomes 10.0×65/64×4080/3808=10.88169643 (Gbps).

Thus, in the frame transmission processing of the present invention, the processing rate required for a network device can be reduced about 1.5% and cost reduction of the network device can be realized. In the frame transmission processing, since an error correcting code is also transmitted together with the signal, data transmission with a high reliability can be performed.

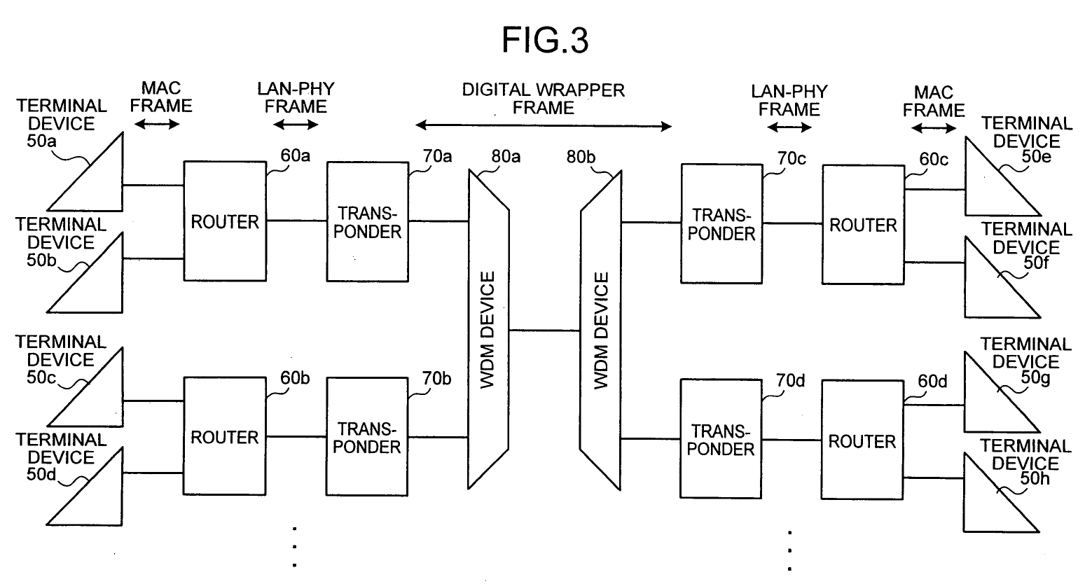

FIG. 3 is a diagram of a configuration of the frame transmitting system according to a first embodiment of the present invention. As shown in FIG. 3, the frame transmitting system is constituted of terminal devices 50a to 50h, routers 60a to 60d, transponders 70a to 70d, and WDM devices 80a and 80b.

Each of the terminal devices 50a to 50h is a device that performs transmission and reception of data with another terminal device. Specifically, when each of the terminal devices 50a to 50h transmits an IP packet to another terminal device, it generates an MAC frame storing the IP packet therein to a corresponding one of the routers 60a to 60d. Each of the terminal devices 50a to 50h receives an MAC frame from a corresponding one of the routers 60a to 60d to perform a processing for taking an IP packet from the MAC frame.

Each of the routers 60a to 60d is a router that selects a proper path through which the MAC frame should be transferred based on address information of a transmission destination of the MAC frame received from each of the terminal devices 50a to 50h and further perform 64B/66B coding processing on the MAC frame.

Each of the routers 60a to 60d performs a processing for converting the LAN-PHY frame obtained by the 64B/66B-coding processing to an optical signal and transmitting the LAN-PHY frame converted to the optical signal to corresponding one of the transponders 70a to 70d on the selected path.

When each of the routers 60a to 60d receives an optical signal of the LAN-PHY frame transmitted from each of the transponders 70a to 70d, it converts the same to an electric signal to reconstruct a MAC frame.

Each of the routers 60a to 60d selects a proper path through which the MAC frame should be transferred based on address information of a transmission destination of the reconstructed MAC frame and performs a processing for transmitting the MAC frame to a corresponding one of the terminal devices 50a to 50h.

Each of the transponders 70a to 70d is a device that converts a LAN-PHY frame received from a corresponding one of the routers 60a to 60d to a digital wrapper frame and transmits the digital wrapper frame to corresponding one of the WDM device 80a and 80b with a predetermined optical wavelength.

When each of the transponders 70a to 70d receives a digital wrapper frame from the corresponding one of the WDM devices 80a and 80b, it performs a processing for converting the digital wrapper frame to a LAN-PHY frame to transmit the same to corresponding one of the routers 60a to 60d. A functional configuration of each of the transponders 70a to 70d will be explained later in detail.

Each of the WDM devices 80a and 80b is a device that, when receiving a digital wrapper frame from corresponding one of the transponder 70a to 70d, performs wavelength multiplexing processing of an optical signal on the digital wrapper frame to transmit the optical signal to an opposing one of the WDM devices 80a and 80b.

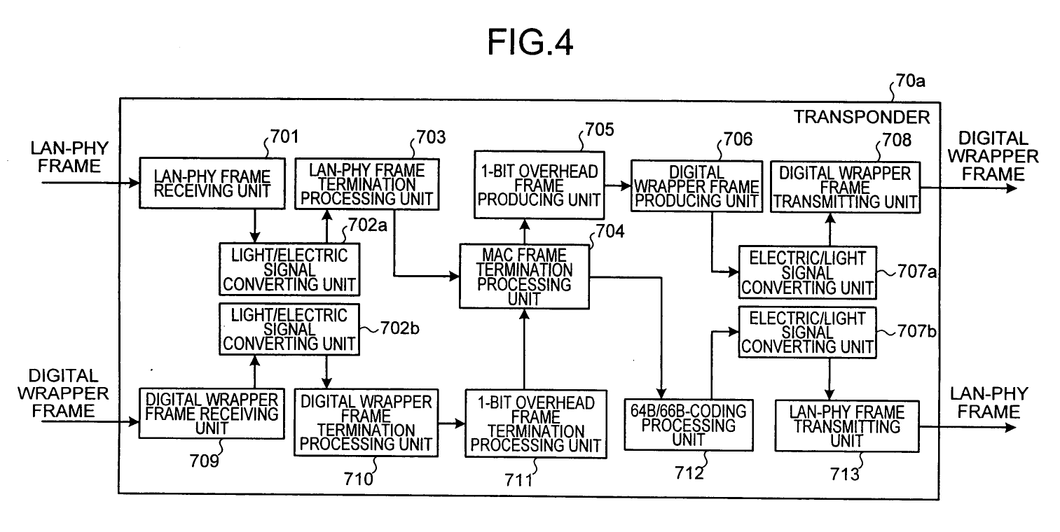

FIG. 4 is a block diagram of a functional configuration of the transponder 70a shown in FIG. 3. Since the respective transponders 70a to 70d have the same functional configuration, only the functional configuration of the transponder 70a will be explained in FIG. 4.

As shown in FIG. 4, the transponder 70a includes a LAN-PHY frame receiving unit 701, optical-electric signal converting units 702a and 702b, a LAN-PHY frame termination processing unit 703, a MAC frame termination processing unit 704, a 1-bit overhead frame generating unit 705, a digital wrapper frame generating unit 706., electric-optical signal converting units 707a and 707b, a digital wrapper frame transmitting unit 708, a digital wrapper frame receiving unit 709, a digital wrapper frame termination processing unit 710, a 1-bit overhead frame termination processing unit 711, a 64B/66B-coding processing unit 712, and a LAN-PHY frame transmitting unit 713.

The LAN-PHY frame receiving unit 701 receives an optical signal of a LAN-PHY frame transmitted from each of the routers 60a to 60d. When the LAN-PHY frame receiving unit 701 receives an optical signal of the LAN-PHY frame, the optical-electric signal converting unit 702a converts the optical signal to an electric signal. When the digital wrapper frame receiving unit 709 receives an optical signal of digital wrapper frame from the WDM device 80a, the optical-electric signal converting unit 702b converts the optical signal to an electric signal.

The LAN-PHY frame termination processing unit 703 analyzes a LAN-PHY frame to determine whether transmission error occurs based on information on a header in the LAN-PHY frame or perform a termination processing for a LAN-PHY frame such as re-constructing a MAC frame.

The MAC frame termination processing unit 704 analyzes a MAC frame re-constructed by the LAN-PHY frame termination processing unit 703 or a MAC frame re-constructed by the 1-bit overhead frame termination processing unit 711 to perform a termination processing for a MAC frame such as detecting whether transmission error of a MAC frame occurs.

The 1-bit overhead frame generating unit 705 generates a 1-bit overhead frame obtained by replacing a 2-bit header in a LAN-PHY frame by a 1-bit header. The digital wrapper producing unit 706 embeds the 1-bit overhead frame generated by the 1-bit overhead frame generating unit 705 in a payload area in a digital wrapper frame and stores operation and management information in OH in the digital wrapper frame, and generates a digital wrapper frame where an error correcting code has been stored in an FEC area.

The electric-optical signal converting unit 707a converts an electric signal of a digital wrapper frame generated by the digital wrapper frame generating unit 706 to an optical signal with a predetermined optical wavelength to be transmitted to the WDM device 80a. The electric-optical signal converting unit 707b converts an electric signal of a LAN-PHY frame generated by the 64B/66B-coding processing unit 712 to an optical signal with a predetermined optical length to be transmitted to the router 60a.

The digital wrapper frame transmitting unit 708 performs a processing for transmitting the digital wrapper frame converted to the optical signal from the electric signal by the electric-optical signal converting unit 707a to the WDM device 80a.

The digital wrapper frame receiving unit 709 receives an optical signal of a digital wrapper frame transmitted from the WDM device 80a. When the optical-electric signal converting unit 702b converts an optical signal of the digital wrapper frame transmitted from the WDM device 80a to an electric signal, the digital wrapper frame termination processing unit 710 receives the electric signal to perform a termination processing for the digital wrapper frame such as analyzing the digital wrapper frame.

Specifically, the digital wrapper frame termination processing unit 710 performs such a processing as a frame synchronizing processing or a correcting processing on transmission error of a frame based on the operation and management information stored in the OH of the digital wrapper frame or the error correcting code stored in the FEC area. The digital wrapper frame termination processing unit 710 performs a processing for taking out the 1-bit overhead frame embedded in the payload area of the digital wrapper frame.

The 1-bit overhead frame termination processing unit 711 analyzes the 1-bit overhead frame taken out by the digital wrapper frame termination processing unit 710 to perform a termination processing for the 1-bit overhead frame for producing a MAC frame from the 1-bit overhead frame. The 1-bit overhead frame termination processing unit 711 determines whether each of 64-bit blocks generated by dividing a MAC frame includes a control code from the 1-bit header in the 1-bit overhead frame.

The 64B/66B-coding processing unit 712 divides a MAC frame into blocks, each containing 64 bits. Further, the 64B/66B-coding processing unit 712 acquires information about the result obtained by determining whether respective blocks each containing 64 bits include a control code from the 1-bit overhead frame termination processing unit 711, and perform a 64B/66B-coding processing for adding a 2-bit header to each block to generate a LAN-PHY frame.

When an amount of transmission error of a frame exceeds a capacity for transmission error correction that the digital wrapper frame termination processing unit 710 can perform and error correction can not be made, the 64B/66B-coding processing unit 712 generates a LAN-PHY frame obtained by adding a 2-bit header “00” or “11” indicating abnormality occurrence in each block instead of addition of the header “01” or “10”.

In the case, such a fact that transmission error has occurred is detected by a check function of Bit Interleaved Parity (BIP) that the digital wrapper frame has. The router 60a that has received the LAN-PHY frame can detect a transmission error occurrence from the information in the header.

The LAN-PHY frame transmitting unit 713 performs a processing for transmitting the LAN-PHY frame converted from an electric signal to an optical signal by the electric-optical signal converting unit 706b to the router 60a.

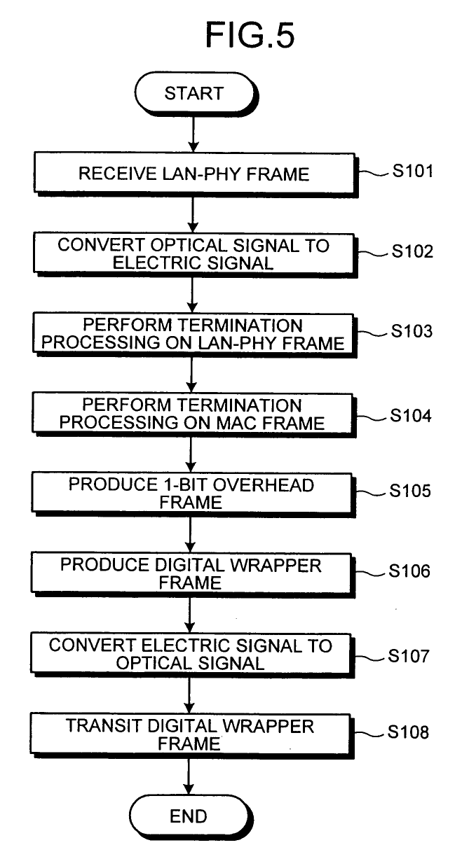

FIG. 5 is a flowchart of a process procedure of a processing for converting a LAN-PHY frame to a digital wrapper frame to transmit the digital wrapper frame.

As shown in FIG. 5, the LAN-PHY frame receiving unit 70 of the transporter 70a first receives a LAN-PHY frame (Step S101). The optical-electric signal converting unit 702a converts an electric signal of the LAN-PHY frame to an optical signal (Step S102).

The LAN-PHY frame termination processing unit 703 performs a termination processing on the LAN-PHY frame (Step S103) and the MAC frame termination processing unit 704 performs a termination processing on the MAC frame converted to the LAN-PHY frame and transmitted (Step S104).

Thereafter, the 1-bit overhead frame generating unit 705 generates a 1-bit overhead frame obtained by replacing a 2-bit header in the LAN-PHY frame by a 1-bit header (Step S105), and the digital wrapper frame generating unit 706 generates a digital wrapper frame obtained by embedding the 1-bit overhead frame in payload area in the digital wrapper frame (Step S106).

The electric-optical signal converting unit 707a converts an electric signal of the digital wrapper frame generated by the digital wrapper frame generating unit 706 to an optical signal (Step S107), and the digital wrapper frame transmitting unit 708 transmits the digital wrapper frame that has been converted to the optical signal to the WDM device 80a (Step S108), thereby terminating the processing for converting a LAN-PHY frame to a digital frame to transmit the digital frame.

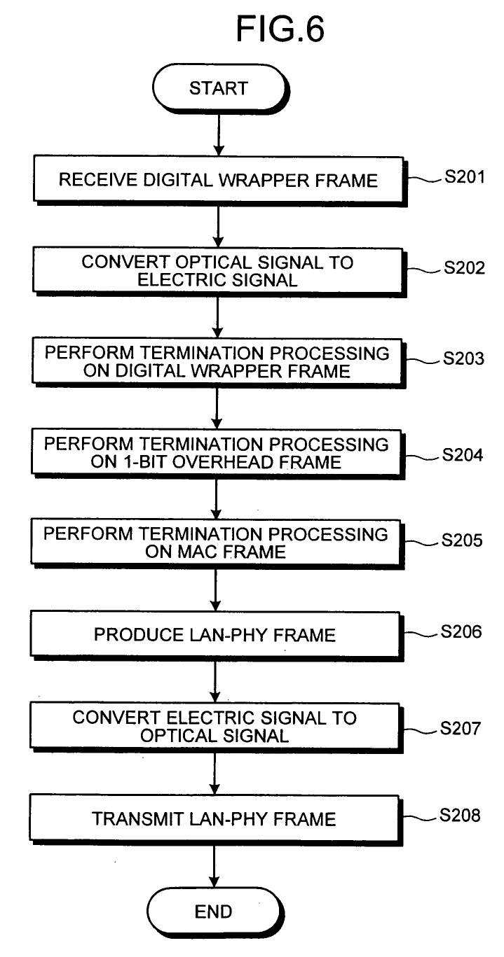

FIG. 6 is a flowchart of a process procedure of a processing for converting a digital wrapper frame to a LAN-PHY frame to transmit the LAN-PHY frame.

As shown in FIG. 6, the digital wrapper frame receiving unit 709 of the transponder 70a first receives a digital wrapper frame transmitted from the WDM device 80a (Step S201). The optical-electric signal converting unit 702b converts an optical signal of a digital wrapper frame to an electric signal (Step S202).

Subsequently, the digital wrapper frame termination processing unit 710 performs a termination processing on the digital wrapper frame (Step S203), and the 1-bit overhead frame termination processing unit 711 performs a termination processing on the 1-bit overhead frame embedded in the payload area in the digital wrapper frame and transmitted (Step S204). Further, the MAC frame termination processing unit 704 performs a termination processing on the MAC frame converted to the 1-bit overhead frame and transmitted (Step S205).

Thereafter, the 64B/66B-coding processing unit 712 generates a LAN-PHY frame where a 1-bit header in the 1-bit overhead frame has been replaced by a 2-bit header (Step S206).

The electric-optical signal converting unit 707b converts an electric signal of the LAN-PHY frame generated by the 64B/66B-coding processing unit 712 to an optical signal (Step S207), and the LAN-PHY frame transmitting unit 713 transmits the LAN-PHY frame converted to the optical signal to the router 60a (Step S208), thereby terminating the processing for converting a digital wrapper frame to a LAN-PHY frame to transmit the LAN-PHY frame.

As described above, according to the first embodiment, since the digital wrapper frame generating unit 706 of the transponder 70a generates a digital wrapper frame including a 1-bit overhead frame added with 1-bit identification information indicating whether each of 64-bit blocks generated by dividing a MAC frame includes a control code and an error correcting code, and the digital wrapper frame transmitting unit 708 transmits the digital wrapper frame, transmission error of the digital wrapper frame can be controlled efficiently and a processing rate required for a device that performs transmission of a digital wrapper frame can be suppressed.

Furthermore, according to the first embodiment, since the digital wrapper frame generating unit 706 generates a digital wrapper frame including a frame synchronizing code referred to for performing frame synchronization, control on transmission error of a digital wrapper frame and digital wrapper frame synchronization can be performed efficiently.

Moreover, according to the first embodiment, since the digital wrapper frame generating unit 706 generates a digital-wrapper-format frame including an error correcting code and a frame synchronizing code, whose payload area includes a 1-bit overhead frame, control on an transmission error of a frame and frame synchronization can be performed efficiently using a digital wrapper frame synchronization, and a processing rate required for a device that performs transmission of a digital wrapper frame can be suppressed.

Furthermore, according to the first embodiment, since the digital wrapper frame receiving unit 709 receives a digital wrapper frame including a 1-bit overhead frame added with 1-bit identification information indicating whether each of 64-bit block generated by dividing a MAC frame includes a control code and an error correcting code, the digital wrapper frame termination processing unit 710 corrects transmission error of a frame based on the error correcting code, and the 64B/66B-coding processing unit 712 converts the MAC frame re-constructed by the MAC frame termination processing unit 704 to the LAN-PHY frame based on the 1-bit identification information concluded in the 1-bit overhead frame, transmission error of the digital wrapper frame can be controlled efficiently and a processing rate required for a device performing transmission of a digital wrapper frame can be suppressed.

Moreover, according to the first embodiment, such a constitution is employed that the 1-bit information identification indicating whether a 64-bit block includes a control code is added, but such a constitution may be employed that instead of addition of the 1-bit header to a block that a digital wrapper frame where information about a control code has been stored in a reservation area of the OH is transmitted.

Specifically, a transponder that transmits a digital wrapper frame performs a processing for removing a control code from a 64-bit block, storing the block from which the control code has been removed in the payload area of the digital wrapper frame, and storing the information about the removed control code in the reservation area of the OH in the digital wrapper frame.

The transponder that has received the digital wrapper frame, it performs a processing for re-constructing a LAN-PHY frame based on the information about the control code stored in the reservation area of the OH and the block stored in the payload area to transmit the LAN-PHY frame to a router or the like.

Such a constitution is employed that addition of a 1-bit header is not performed and a control code included in a block is further removed, but it is unnecessary to remove a control code necessarily. In that case, information about whether a block includes a control code is stored in a reservation area of the OH in the digital wrapper frame.

Thus, according to a modification of the first embodiment, since, when a 64-bit block includes a control code, the transponder generates a digital wrapper frame by storing a block including a control code or a block from which a control code has been removed in the payload area in the digital-wrapper-format frame including an error correcting code and storing information about the control code in the reservation area of the overhead in the digital-wrapper-format frame and transmits the generated digital wrapper frame, transmission error of the digital wrapper frame can be controlled efficiently and a processing rate required for a device performing transmission of a digital wrapper frame can be suppressed.

Furthermore, according to the modification of the first embodiment, since, when a 64-bit block includes a control code, the transponder receives a frame generated by storing a block including a control code or a block from which a control code has been removed in the payload area in the digital-wrapper-format frame including an error correcting code and storing information about the control code in the reservation area of the overhead in the digital-wrapper-format frame, performs correction on transmission error of data based on the error correction code included in the reservation frame, and performs frame format conversion based on the information about the control code, transmission error of data can be corrected efficiently and a processing rate required for a device performing transmission of data can be suppressed.

According to the first embodiment, such a constitution is employed that a transponder performs a processing for producing a digital wrapper frame to transmit the same, but a router may perform such a processing. According to a second embodiment of the present invention, a case that a router performs the processing will be explained.

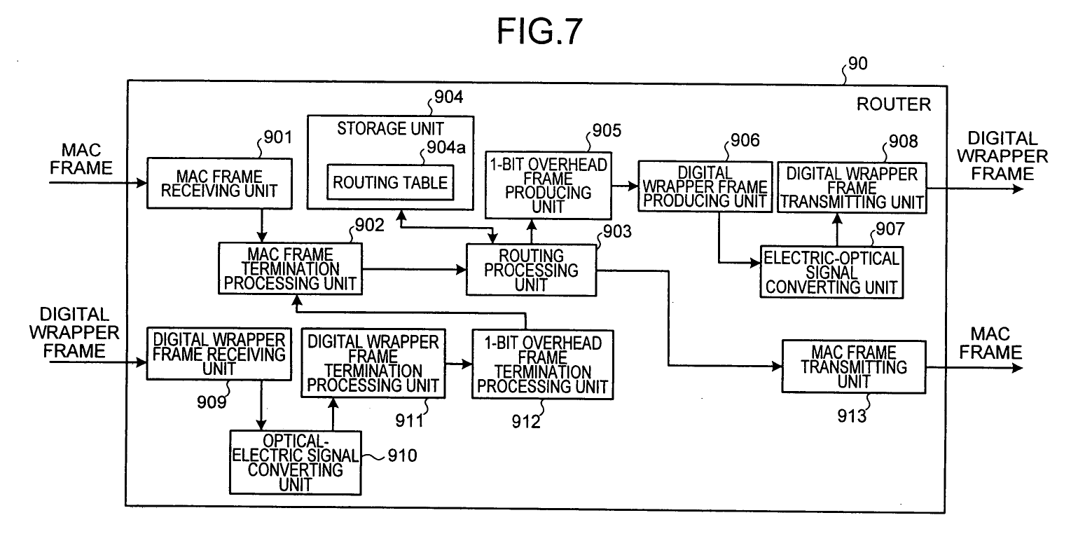

FIG. 7 is a block diagram of a functional configuration of a router according to the second embodiment. Detailed explanation about functional units having the same functions as those in the transponder 70a shown in FIG. 4 will be omitted.

As shown in FIG. 7, the router 90 includes a MAC frame receiving unit 901, a MAC frame termination processing unit 902, a routing processing unit 903, a storage unit 904, a 1-bit overhead frame generating unit 905, a digital wrapper frame generating unit 906, an electric-optical signal converting unit 907, a digital wrapper frame transmitting unit 908, a digital wrapper frame receiving unit 909, an optical-electric signal converting unit 910, a digital wrapper frame termination processing unit 911, a 1-bit overhead frame termination processing unit 912, and a MAC frame transmitting unit 913.

The MAC frame receiving unit 901 receives an electric signal of a MAC frame transmitted from a terminal device. The MAC frame termination processing unit 902 performs such a termination processing of a MAC frame as analyzing the MAC frame that the MAC frame receiving unit 901 has received to detect whether transmission error of the MAC frame has occurred.

The routing processing unit 903 refers to a routing table 904a stored in the storage unit 904 to perform a processing a processing for selecting a proper path through which the digital wrapper frame or the MAC frame should be transferred based on address information about a transmission destination included in the MAC frame.

The storage unit 904 is a storage device storing data therein, such as a memory. The storage unit 904 stores the routing table 904a. Address information about a final transmission destination of data and address information about a transmission destination to be first transmitted with the data are stored in the routing table 904a with a correspondence between both the information in order to transmit the data to the final transmission destination.

The 1-bit overhead frame generating unit 905 generates a 1-bit overhead frame obtained by adding a 1-bit header to each of blocks obtained by dividing a MAC frame to respective 64 bits. Specifically, when a control code is included in a 64-bit block, the 1-bit overhead frame generating unit 905 generates a 1-bit overhead frame with a header having a value of “1”, while it generates a 1-bit overhead frame with a header having a value of “0”, when a control code is not included in the 64-bit block.

The digital wrapper frame generating unit 906 performs a processing for embedding the 1-bit overhead frame generated by the 1-bit overhead frame generating unit 905 into a payload area in the digital wrapper frame and storing operation and management information in the OH in the digital wrapper frame, and further producing a digital wrapper frame where an error correcting code has been stored in an FEC area.

The electric-optical signal converting unit 907 converts an electric signal of the digital wrapper frame generated by the digital wrapper frame generating unit 906 to an optical signal with a predetermined optical wavelength to be transmitted to the WDM device. The digital wrapper frame transmitting apparatus 908 transmits the digital wrapper frame converted from the electric signal to the optical signal by the electric-optical signal converting unit 907 to the WDM device.

The digital wrapper frame receiving unit 909 receives the optical signal of the digital wrapper frame transmitted from the WDM device. When the digital wrapper frame receiving unit 909 receives the optical signal of the digital wrapper frame from the WDM device, the optical-electric signal converting unit 910 converts the optical signal to an electric signal.

When the optical signal of the digital wrapper frame transmitted from the WDM device is converted to an electric signal by the optical-electric signal converting unit 910, the digital wrapper frame termination processing unit 911 receives the electric signal to perform a termination processing on the digital wrapper frame.

Specifically, the digital wrapper frame termination processing unit 911 performs such a processing as a frame synchronizing processing or transmission error correcting processing of a frame based on the operation and management information stored in the OH of the digital wrapper frame or the error correcting code stored in the FEC area. The digital wrapper frame termination processing unit 911 performs a processing for taking out the 1-bit overhead frame embedded in the payload area in the digital wrapper frame.

The 1-bit overhead frame termination processing unit 912 performs such a termination processing on the 1-bit overhead frame as analyzing the 1-bit overhead frame taken out by the digital wrapper frame termination processing unit 911 to generate a MAC frame from the 1-bit overhead frame.

When termination processing on the 1-bit overhead frame included in the digital wrapper frame has been performed by the 1-bit overhead frame termination processing unit 912, the MAC frame termination processing unit 902 performs a processing for re-constructing a MAC frame from the 1-bit overhead frame. The MAC frame transmitting unit 913 performs a processing for transmitting the MAC frame via the path selected by the routing processing unit 903.

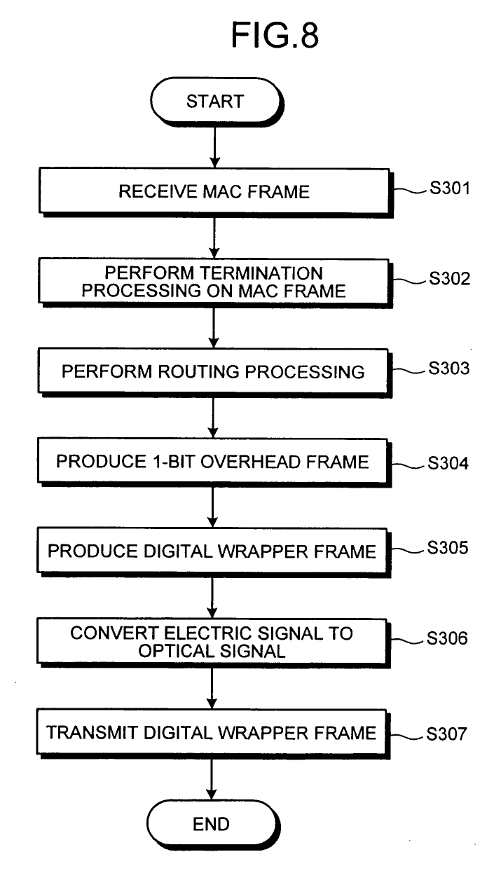

FIG. 8 is a flowchart of the processing for converting a MAC frame to a digital wrapper frame to transmit. As shown in FIG. 8, first, the MAC frame receiving unit 901 of the router 90 receives a MAC frame transmitted from a terminal device (Step S301). The MAC frame termination processing unit 902 performs a termination processing on the MAC frame (Step S302).

Subsequently, the routing processing unit 903 performs a routing processing for referring to the routing table 904a stored in the storage unit 904 to select a proper path through which the MAC frame should be transferred based on the address information of the transmission destination included in the MAC frame (Step S303).

The 1-bit overhead frame generating unit 905 generates a 1-bit overhead frame added with header of 1 bit to each of blocks obtained by dividing a MAC frame (Step S304). Subsequently, the digital wrapper frame generating unit 906 generates a digital wrapper frame having a 1-bit overhead frame embedded in the payload area (Step S305).

Thereafter, the electric-optical converting unit 907 converts an electric signal of the digital wrapper frame generated by the digital wrapper frame generating unit 906 to an optical signal (Step S306), and the digital wrapper frame transmitting unit 908 transmits the digital wrapper frame converted to the optical signal to the WDM device on the path selected by the routing processing unit 903 (Step S307), thereby terminating the processing for converting a MAC frame to a digital wrapper frame to transmit the same.

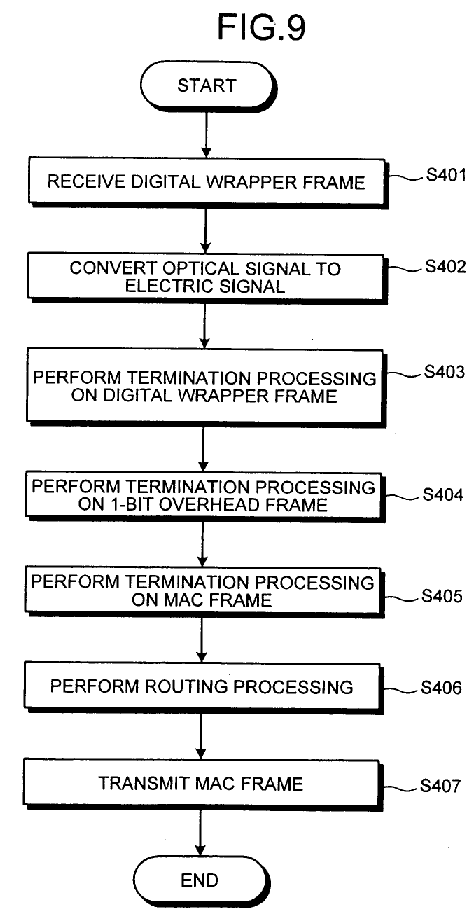

FIG. 9 is a flowchart of a process procedure of a processing for converting a digital wrapper frame to a MAC frame to transmit. As shown in FIG. 9, the digital wrapper frame receiving unit 909 of the router 90 first receives a digital wrapper frame from a WDM device (Step S401). The optical-electric signal converting unit 910 converts an optical signal of the digital wrapper frame to an electric signal (Step S402).

Subsequently, the digital wrapper frame termination processing unit 911 performs a termination processing on the digital wrapper frame (Step S403), and the 1-bit overhead frame termination processing unit 912 performs a termination processing on the 1-bit overhead frame embedded in the payload area in the digital wrapper frame and transmitted (Step S404). Further, the MAC frame termination processing unit 902 performs a termination processing on the MAC frame converted into the 1-bit overhead frame and transmitted (Step S405).

Thereafter, the routing processing unit 903 performs a routing processing for referring to the routing table 904a stored in the storage unit 904 to select a proper path through which the MAC frame should be transferred based on the address information of the transmission destination included in the MAC frame (Step S406).

Then, the MAC frame transmitting unit 913 transmits the MAC frame to a terminal device via the path selected by the routing processing unit 903 (Step S407), thereby terminating the processing for converting a digital wrapper frame to a MAC frame to transmit the same.

As described above, according to the second embodiment, since the routing processing unit 903 selects the transmission path through which the digital wrapper frame should be transmitted based on the routing table 904a stored in the storage unit 904 of the router 90 in advance, and the digital wrapper frame transmitting unit 908 transmits the digital wrapper frame via the transmission path selected by the routing processing unit 903, transmission error of a digital wrapper frame can be controlled efficiently in the router 90, and a processing rate required for a device performing transmission of the digital wrapper frame can be suppressed.

According to the first and the second embodiments, such a constitution is employed that the transponder or the router performs the processing for producing the digital wrapper frame to transmit the same, but an uninterruptible device may perform the processing. According to a third embodiment of the present invention, a case that an uninterruptible device performs a processing for producing a digital wrapper frame to transmit the same will be explained.

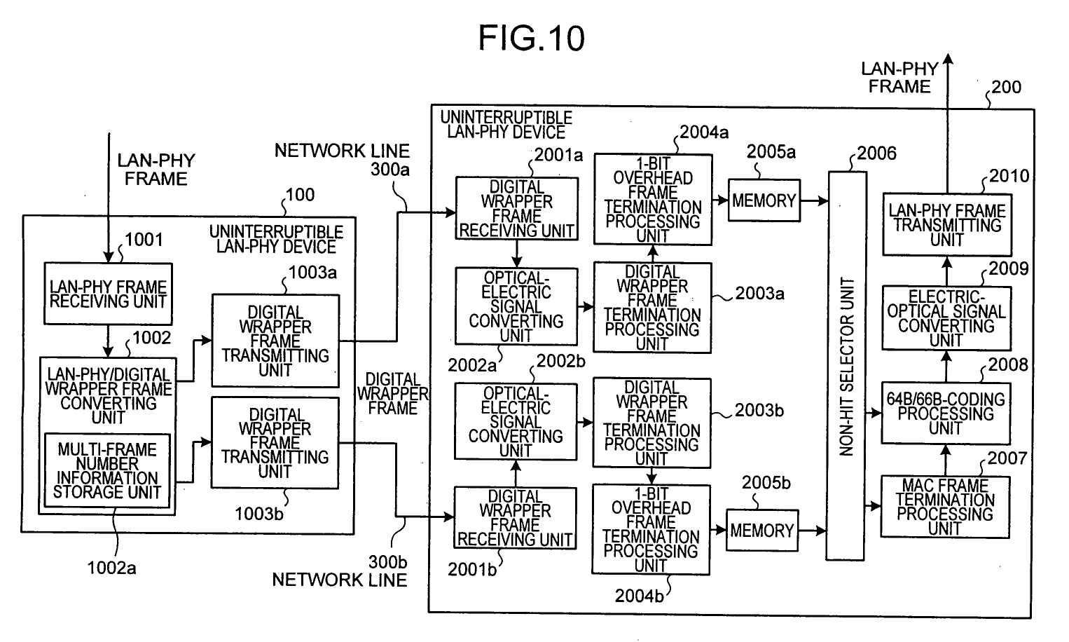

FIG. 10 is a block diagram of functional configurations of uninterruptible LAN-PHY devices 100 and 200. In FIG. 10, such a case is shown that the uninterruptible LAN-PHY device 100 converts a LAN-PHY frame received from a router or the like to a digital wrapper frame to transmit the same, and the uninterruptible LAN-PHY device 200 converts a digital wrapper frame received from the uninterruptible LAN-PHY device 100 to a LAN-PHY frame to transmit the same to a router or the like.

Incidentally, though omitted in FIG. 10, the uninterruptible LAN-PHY device 100 and the uninterruptible LAN-PHY device 200 includes similar functional units and they can realize the same function.

That is, the uninterruptible LAN-PHY device 200 can convert a LAN-PHY frame received from a router or the like to a digital wrapper frame to transmit the same, while the uninterruptible LAN-PHY device 100 can convert a digital wrapper frame received from the uninterruptible LAN-PHY device 200 to a LAN-PHY frame to transmit the same.

As shown in FIG. 10, the uninterruptible LAN-PHY device 100 includes a LAN-PHY frame receiving unit 1001, a LAN-PHY/digital wrapper frame converting unit 1002, and digital wrapper frame transmitting units 1003a and 1003b.

The LAN-PHY frame receiving unit 1001 performs a processing for receiving a LAN-PHY frame from a router or the like. The LAN-PHY/digital wrapper frame converting unit 1002 converts a LAN-PHY frame to a digital wrapper frame.

Specifically, the LAN-PHY/digital wrapper frame converting unit 1002 is provided with functions approximately equivalent to the LAN-PHY frame receiving unit 701, the optical-electric signal converting unit 702a, the LAN-PHY frame termination processing unit 703, the MAC frame termination processing unit 704, the 1-bit overhead producing unit 705, the digital wrapper frame generating unit 706, and the electric-optical signal converting unit 707a that are shown in FIG. 4.

Incidentally, the LAN-PHY/digital wrapper frame converting unit 1002 further includes a multi-frame number information storage unit 1002a. The multi-frame number information storage unit 1002a converts a LAN-PHY frame to a 1-bit overhead frame, and stores multi-frame number information in an OH in a digital wrapper frame when embedding the 1-bit overhead frame in a payload area of the digital wrapper frame.

The multi-frame number means an identification number commonly allocated to digital wrapper frames with the same content when the digital wrapper frames with the same content are transmitted in parallel via two network lines 300a and 300b.

According to the third embodiment, such a constitution is employed that the digital wrapper frame is transmitted via the two network lines 300a and 300b in parallel, but this invention is not limited to this constitution. The digital wrapper frame may be transmitted via three or more network lines in parallel.

The LAN-PHY/digital wrapper frame converting unit 1002 outputs digital wrapper frame storing multi-frame number information stored in the OH to the digital wrapper frame transmitting units 1003a and 1003b.

The digital wrapper frame transmitting units 1003a and 1003b perform processings for transmitting digital wrapper frame generated by the LAN-PHY/digital wrapper frame converting unit 1002 via different network lines 300a and 300b, respectively.

The uninterruptible LAN-PHY device 200 includes digital wrapper frame receiving units 2001a and 2001b, optical-electric signal converting units 2002a and 2002b, digital wrapper frame termination processing units 2003a and 2003b, 1-bit overhead frame termination processing units 2004a and 2004b, memories 2005a and 2005b, an uninterruptible selector 2006, a MAC frame termination processing unit 2007, a 64B/66B-coding processing unit 2008, an electric-optical signal converting unit 2009, and a LAN-PHY frame transmitting unit 2010.

Each of the digital wrapper frame receiving units 2001a and 2001b receives an optical signal of a digital wrapper frame transmitted from the uninterruptible LAN-PHY device 100. Each of the optical-electric signal converting units 2002a and 2002b converts an optical signal that corresponding one of the digital wrapper frame receiving units 2001a and 2001b receives to an electric signal.

Each of the digital wrapper frame termination processing units 2003a and 2003b performs a frame synchronizing processing and a frame transmission error correcting processing based on operation and management information stored in the OH of the digital wrapper frame or the error correcting code stored in the FEC area.

Each of the digital wrapper frame termination processing units 2003a and 2003b analyzes data embedded in the payload area of the digital wrapper frame to take out the 1-bit overhead frame. Further, each of the digital wrapper frame termination processing units 2003a and 2003b acquires the multi-frame number information stored in the OH in the digital wrapper frame from the multi-frame number information storage unit 1002a of the uninterruptible LAN-PHY device 100.

Each of the 1-bit overhead frame termination processing units 2004a and 2004b analyzes data embedded in the payload area of the digital wrapper frame to perform a termination processing on the 1-bit overhead frame from which the MAC frame is generated.

Each of the 1-bit overhead frame termination processing units 2004a and 2004b determines, from the header of 1 bit in the 1-bit overhead frame, whether each of 64-bit blocks generated by dividing the MAC frame includes a control code to output the determination result to the uninterruptible selector 2006 via corresponding one of the memories 2005 and 2005b.

Each of the memories 2005a and 2005b is a buffer memory that temporarily stores data such as the MAC frame generated by corresponding one of the 1-bit overhead frame termination processing units 2004a and 2004b.

The uninterruptible selector 2006 acquires multi-frame number information elements from the digital wrapper frame termination processing units 2003a and 2003b and identifies MAC frames with the same content transmitted via the two network lines 300a and 300b in parallel from each other to output the MAC frame transmitted via one of the network lines 300a and 300b to the MAC frame termination processing unit 2007.

The uninterruptible selector 2006 determines whether a failure occurs in any of the network lines 300a and 300b based on an accumulation state of MAC frames in the memories 2005a and 2005b. When a failure occurs in one of the network lines 300a and 300b outputting MAC frames to the MAC frame termination processing unit 2007, a selector processing is performed to output the MAC frame transmitted via the. other of the network lines 300a and 300b to the MAC frame termination processing unit 2007.

The MAC frame termination processing unit 2007 analyzes the MAC frame received from the uninterruptible selector unit 2006 to perform such a termination processing on the MAC frame as detecting whether transmission error of a MAC frame occurs.

The 64B/66B-coding processing unit 2008 divides a MAC frame to 64-bit blocks. The 64B/66B-coding processing unit 2008 acquires information about the determination result of whether each of the 64-bit blocks includes a control code from the uninterruptible selector unit 2006 and performs the 64B/66B-coding processing for adding a 2-bit header to each block based on the information to generate a LAN-PHY frame.

The electric-optical signal converting unit 2009 converts an electric signal of the LAN-PHY frame generated by the 64B/66B-coding processing unit 2008 to an optical signal with a predetermined optical wavelength to be transmitted to a router or the like. The LAN-PHY frame transmitting unit 2010 performs a processing for transmitting the LAN-PHY frame converted from the electric signal to the optical signal by the electric-optical converting unit 2009 to a router or the like.

Incidentally, a process procedure of a processing for converting a LAN-PHY frame to a digital wrapper frame that is performed by the uninterruptible LAN-PHY device 100 is approximately similar to the process procedure shown in FIG. 5.

The process procedure according to the third embodiment is different from the process procedure shown in FIG. 5 in that, when a digital wrapper frame is generated at the Step S106 shown in FIG. 5, the multi-frame number information storage unit 1002a in the uninterruptible LAN-PHY device 100 stores multi-frame number information in the OH in the digital wrapper frame.

A process procedure of a processing for converting a LAN-PHY frame to a digital wrapper frame that is performed by the uninterruptible LAN-PHY device 200 is approximately similar to the process procedure shown in FIG. 6.

The process procedure according to the third embodiment is different from the process procedure shown in FIG. 6 in that the processing from Step S201 to S204 shown in FIG. 6 is performed on data elements transmitted through two network lines 300a and 300b, and after the termination processing on the 1-bit overhead frame shown at Step S204 shown in FIG. 6 is terminated, a MAC frame is buffered into the memories 2005a and 2005b and the uninterruptible selector unit 2006 performs a selecting processing between the networks 300a and 300b in response to presence/absence of a failure in any of the networks 300a and 300b.

As described above, according to the third embodiment, since the multi-frame number information storage unit 1002a in the uninterruptible LAN-PHY device 100 stores multi-frame number information that identifies frames including the same content in the reservation area on the overhead (OH) in the digital wrapper frame, and the digital wrapper frame transmitting units 1003a and 1003b transmit a digital wrapper frame stored in the OH via a plurality of network lines 300a and 300b, transmission error of a digital wrapper frame can be controlled efficiently in the uninterruptible LAN-PHY device 100 that transmits a digital wrapper frame via a plurality of network lines 300a and 300b, and a processing rate required for a device performing a digital wrapper frame can be suppressed.

The exemplary embodiments according to the present invention have been explained; however the present invention is not limited to the embodiments. The present invention can be implemented as various different embodiments within a scope and spirit of the technical idea described in appending Claims.

According to the embodiments, for example, the case that the LAN-PHY frame or the MAC frame is converted to the digital wrapper frame and the digital wrapper frame is restored to the LAN-PHY frame or the MAC frame, but the present invention is not limited to the case. The present invention is applicable to a case that an interface of 10 Gigabit Media Independent Interface (XGMII)/10 Gigabit Attachment Unit Interface (XAUI) is converted to a digital wrapper frame and the digital wrapper frame is restored to the interface of XGMII/XAUI.

When the digital wrapper frame is restored to the XGMII/XAUI interface, transmission error occurred in the digital wrapper frame is corrected by a transmission error correcting function of the digital wrapper.

Even if the degree of transmission error exceeds the transmission error correcting capability of the digital wrapper frame and the error can not be corrected, the error occurrence can be notified to a device that is a communication partner by transmitting a control code indicating error occurrence with addition to the XGMII/XAUI interface.

Some of all of respective processings explained in the embodiments as processings automatically performed may be performed manually, or some of all of respective processings explained as processings manually performed may be automatically performed. Besides, the process procedures, the control procedures, the specific names, and the information elements including various data elements and parameters may be modified arbitrarily except for special notices.

Respective constituent elements of respective devices illustrated are only functional and conceptual ones, and they are not required to have physical configurations as illustrated. That is, a specific aspect of distribution/centralization of respective devices is not limited to the illustrated one, but all or some of the devices can be constituted to be distributed/centralized functionally or physically according to various loads or statuses of use. Further, all or some of respective processing functions performed by respective devices can be realized by a CPU and a program analyzed and performed by the CPU or can be realized as a hardware based on a wired logic.

According to the present invention, since a frame including an identification-information-added data added with identification information of one bit indicating whether a block obtained by dividing data for each n (n is a positive integer) includes control data, and an error control code concerning control on transmission error of data is generated, and a frame generated is transmitted, transmission error of data can be controlled efficiently and a processing rate required for a device for performing data transmission can be suppressed.

Furthermore, according to the present invention, since a frame including a frame synchronizing code concerning frame synchronization is generated, control on transmission error of data and frame synchronization can be performed efficiently.

Moreover, according to the present invention, since a frame including identification-information-added data in a payload area of a digital-wrapper-format frame including an error control code and a frame synchronizing code is generated, control on transmission error of data and frame synchronization can be performed efficiently using a digital wrapper frame synchronized, and a processing rate required for a device for performing data transmission can be suppressed.

Furthermore, according to the present invention, since a frame identifying information that identifies a frame including data with the same content in a predetermined area on an overhead in the frame of digital wrapper format is stored and a frame having frame identifying information store in an overhead thereof is transmitted via a plurality of network lines, transmission error of data can be controlled efficiently in an uninterruptible device that transmits a frame via a plurality of network lines or the like, and a processing rate required for a device for performing data transmission can be suppressed.

Moreover, according to the present invention, since a transmission path through which a frame should be transmitted is selected based on path information stored in advance and a frame is transmitted through the selected transmission path, transmission error of data can be controlled efficiently, and a processing rate required for a device for performing data transmission can be suppressed.

Furthermore, according to the present invention, since a frame including an identification-information-added data added with 1-bit identification information indicating whether a block obtained by dividing data for each n (n is a positive integer) includes control data, and an error control code concerning control on transmission error of data is received, control on transmission error of data is performed based on the error control code included in the received frame, and when control on transmission error of data has been performed, conversion of a frame format is performed based on the identification information, transmission error of data can be controlled efficiently, and a processing rate required for a device for performing data transmission can be suppressed.

Moreover, according to the present invention, since, when each of blocks obtained by dividing data to respective n (n is a positive integer) bits includes control data, a block which includes control data or a block from which control data has been removed is stored in a payload area in a digital-wrapper-format frame including an error control code, a frame is generated by storing information concerning the control date in a predetermined area in an overhead of the digital wrapper format, and the generated frame is transmitted, transmission error of data can be controlled efficiently, and a processing rate required for a device for performing data transmission can be suppressed.

Furthermore, according to the present invention, since, when each of blocks obtained by dividing data to respective n (n is a positive integer) bits includes control data, a block which includes control data or a block from which control data has been removed is stored in a payload area in a digital-wrapper-format frame including an error control code, a frame generated by storing information concerning the control date in a predetermined area in an overhead of the digital wrapper format is received, control on transmission error of data is performed based on the error control code included in the received frame, and when the control on transmission error of data has been performed, conversion of frame format is performed based on information concerning the control data, transmission error of data can be controlled efficiently, and a processing rate required for a device for performing data transmission can be suppressed.

Moreover, according to the present invention, since a frame including an identification-information-added data added with one-bit identification information indicating whether each of blocks obtained by dividing data for each n (n is a positive integer) includes control data, and an error control code concerning control on transmission error of data is generated and the frame is transmitted when the transmitted frame is received, control on transmission error of data is performed based on the error control code included in the received frame, and when the control on transmission error of data has been performed, conversion of frame format is performed based on the identification information, transmission error of data can be controlled efficiently, and a processing rate required for a device for performing data transmission can be suppressed.

Furthermore, according to the present invention, since, when each of blocks obtained by dividing data to respective n (n is a positive integer) bits includes control data, a block which includes control data or a block from which control data has been removed is stored in a payload area in a digital-wrapper-format frame including an error control code, a frame is generated by storing information concerning the control date in a predetermined area in an overhead of the digital wrapper format and the generated frame is transmitted, when the transmitted frame is received, control on transmission error of data is performed based on the error control code included in the received frame, and when control on transmission error of data has been performed, conversion of frame format is performed based on information concerning the control data, transmission error of data can be controlled efficiently, and a processing rate required for a device for performing data transmission can be suppressed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A frame transmitting apparatus that transmits a frame including data to be transmitted or a frame including control data for a data-transmission control via a network, the frame transmitting apparatus comprising:
a frame generating unit that generates a frame including identification-information-added data to which 1-bit identification information indicating whether a block obtained by dividing data into every n bits includes the control data is added, where n is a positive integer, and an error control code for a data-transmission error control; and
a frame transmitting unit that transmits the frame generated.

2. The frame transmitting apparatus according to claim 1, wherein the frame generating unit generates a frame including a frame synchronizing code for a frame synchronization.

3. The frame transmitting apparatus according to claim 2, wherein the frame generating unit generates a frame including the identification-information-added data in a payload area of a digital-wrapper-format frame including the error control code and the frame synchronizing code.

4. The frame transmitting apparatus according to claim 3, wherein
the frame generating unit stores frame identifying information for identifying a frame including data of a same content in a predetermined area of an overhead in the digital-wrapper-format frame, and
the frame transmitting unit transmits a frame having the frame identifying information stored in an overhead thereof via a plurality of network lines.

5. The frame transmitting apparatus according to claim 1, wherein the frame transmitting unit selects a transmission path through which a frame should be transmitted, based on path information stored in advance, and transmits the frame through the transmission path selected.

6. A frame receiving apparatus that receives a frame including data to be transmitted or a frame including control data for a data-transmission control, the frame receiving apparatus comprising:
a frame receiving unit that receives a frame including identification-information-added data to which 1-bit identification information indicating whether a block obtained by dividing data into every n bits includes the control data is added, where n is a positive integer, and an error control code for a data-transmission error control;
a transmission-error control unit that executes a data-transmission error control based on the error control code included in the frame received; and
a format converting unit that performs, when the data-transmission error control has been executed, a conversion of a frame format based on the identification information.

7. A frame transmitting apparatus that transmits a frame including data to be transmitted or a frame including control data for a data-transmission control via a network, the frame transmitting apparatus comprising:
a frame generating unit that generates a frame by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format; and
a frame transmitting unit that transmits the frame generated.

8. A frame receiving apparatus that receives a frame including data to be transmitted or a frame including control data for a data-transmission control, the frame receiving apparatus comprising:
a frame receiving unit that receives a frame generated by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format;
a transmission-error control unit that executes a data-transmission error control based on the error control code included in the frame received; and
a format converting unit that performs, when the data-transmission error control has been executed, a conversion of a frame format based on the information relating to the control data.

9. A method of transmitting a frame including data to be transmitted or a frame including control data for a data-transmission control via a network, and receiving the frame transmitted, the method comprising:
generating a frame including identification-information-added data to which 1-bit identification information indicating whether a block obtained by dividing data into every n bits includes the control data is added, where n is a positive integer, and an error control code for a data-transmission error control;
transmitting the frame generated;
receiving the frame transmitted;
executing a data-transmission error control based on the error control code included in the frame received; and
performing, when the data-transmission error control has been executed, a conversion of a frame format based on the identification information.

10. A method of transmitting a frame including data to be transmitted or a frame including control data for a data-transmission control via a network, and receiving the frame transmitted, the method comprising:
generating a frame by storing, when a block obtained by dividing data into every n bits includes the control data, where n is a positive integer, a block that includes the control data or a block from which the control data has been removed in a payload area of a digital-wrapper-format frame including an error control code, and storing information relating to the control data in a predetermined area of an overhead of the digital wrapper format;
transmitting the frame generated;
receiving the frame transmitted;
executing a data-transmission error control based on the error control code included in the frame received; and
performing, when the data-transmission error control has been executed, a conversion of a frame format based on the information relating to the control data.
